(19) United States
(12) Patent Application Publication
(10) Pub. No.: US 2017/0187587 A1
(43) Pub. Date: Jun. 29, 2017

(54) Technologies for inline network traffic performance tracing

(71) Applicants: David Keppel, Mountain View, CA (US); James Dinan, Hudson, MA (US); Robert C. Zak, Bolton, MA (US)

(72) Inventors: David Keppel, Mountain View, CA (US); James Dinan, Hudson, MA (US); Robert C. Zak, Bolton, MA (US)

(21) Appl. No.: 14/998,208

(22) Filed: Dec. 26, 2015

(51) Int. Cl. H04L 12/26; H04L 12/947; H04L 29/06; H04L 12/861

(52) U.S. Cl. CPC H04L 43/062; H04L 49/9042; H04L 43/10; H04L 49/25; H04L 69/22

(57) ABSTRACT

Technologies for tracing network performance in a high performance computing (HPC) network include a network computing device configured to receive a network packet from a source endpoint node and store the header and trace data of the received network packet to a trace buffer of the network computing device. The network computing device is further configured to retrieve updated trace data from the trace buffer and update the trace data portion of the network packet to include the retrieved updated trace data from the trace buffer. Additionally, the network computing device is configured to transmit the updated network packet to a target endpoint node, in which the trace data of the updated network packet is usable by the target endpoint node to determine inline performance of the network relative to a flow of the network packet. Other embodiments are described and claimed herein.

### GOVERNMENT RIGHTS CLAUSE

This invention was made with Government support under contract number H98230-13-D-0124 awarded by the Department of Defense. The Government has certain rights in this invention.

### BACKGROUND

Network operators and communication service providers typically rely on complex, large-scale computing environments, such as high-performance computing (HPC) and cloud computing environments. Due to the complexities associated with such large-scale computing environments, communication performance issues in such HPC systems can be difficult to detect and correct. This problem can be more difficult for performance anomalies (e.g., incast), which can result from the dynamic behavior of an application running on the system or the behavior of the system itself.

For example, partitioned global address space (PGAS) applications that perform global communication at high message rates can incur network congestion that may be exacerbated by system noise, which may result in performance degradation. Accordingly, HPC systems typically depend on efficient use of the inter-node HPC fabric; however, for many applications, performance is generally limited by HPC fabric performance, as well as by processor, memory, or mass storage performance. Further, due to the complexities associated with HPC system architectures, such HPC fabric performance may be difficult to measure and traffic patterns difficult to understand, making it difficult to identify a root cause of performance problems within the HPC fabric.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for inline performance tracing of network traffic through a network computing device of an HPC network that communicatively couples a source endpoint node and a target endpoint node;

FIG. 2 is a simplified block diagram of at least one embodiment of the source endpoint node of the system of FIG. 1;

FIG. 3 is a simplified block diagram of at least one embodiment of the network computing device of the system of FIG. 1;

FIG. 4 is a simplified block diagram of at least one embodiment of the target endpoint node of the system of FIG. 1;

FIG. 5 is a simplified block diagram of at least one embodiment of an environment that may be established by the source endpoint node of FIG. 2;

FIG. 6 is a simplified block diagram of at least one embodiment of an environment that may be established by the network computing device of FIG. 3;

FIG. 7 is a simplified block diagram of at least one embodiment of an environment that may be established by the target endpoint node of FIG. 4;

FIG. 8 is a simplified block diagram of at least one embodiment of a network packet flow illustrating trace data being forwarded through the HPC network of the system of FIG. 1;

FIG. 9 is a simplified communication flow diagram of at least one embodiment of a network traffic performance tracing flow that may be executed between the source endpoint node of FIGS. 2 and 5, the network computing device of FIGS. 3 and 6, and the target endpoint node of FIGS. 4 and 7;

FIG. 10 is a simplified flow diagram of at least one embodiment of a method for inserting trace data into a network packet that may be executed by the network computing device of FIGS. 3 and 6; and

FIG. 11 is a simplified flow diagram of at least one embodiment of a method for storing trace data of a network packet that may be executed by the target endpoint node of FIGS. 4 and 7.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media (e.g., memory, data storage, etc.), which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

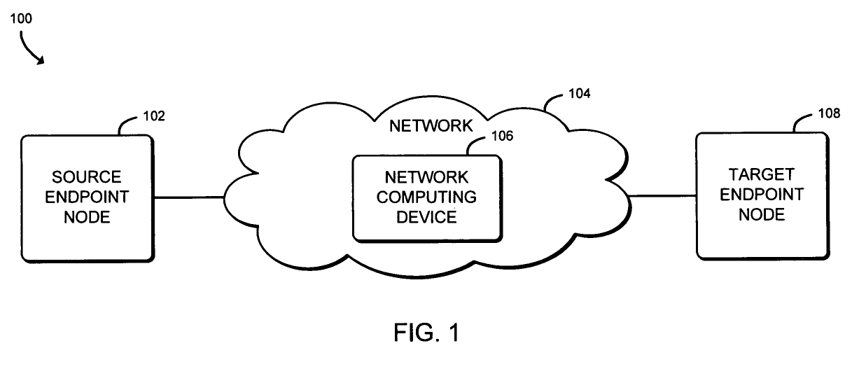

Referring now to FIG. 1, in an illustrative embodiment, a system 100 for inline performance tracing of network traffic through a network computing device 106 of a high performance computing (HPC) network 104 that communicatively couples a source endpoint node 102 to a target endpoint node 108. In use, the network computing device 106 performs various operations (e.g., processing services, analysis, forwarding, etc.) on network traffic (i.e., network packets, messages, etc.) received at the network computing device 106. It should be appreciated that the received network traffic may be forwarded (e.g., to other network computing devices (not shown) of the HPC network 104 communicatively coupled to the network computing device 106) or dropped, depending on results of the operations performed thereon.

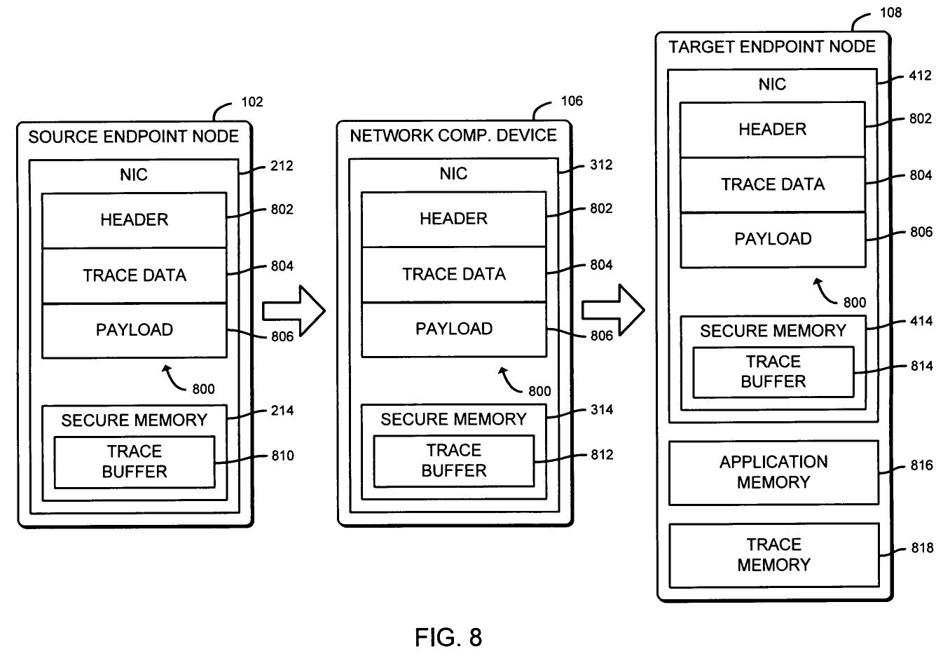

As a network packet flows through the system 100 (see, e.g., the network packet flow of FIG. 8), each of the source endpoint node 102, the network computing device 106, and the target endpoint node 108 are configured to record trace data and optionally fill in fields of the network packet with the trace data. To do so, the source endpoint node 102, the network computing device 106, and/or the target endpoint node 108 may each be configured to utilize a tracing engine, described in further detail below, to track or otherwise monitor performance related data (i.e., trace data) of the network traffic passing through the HPC network 104. In some embodiments, the source endpoint node 102, the network computing device 106, and/or the target endpoint node 108 may each be configured to use trace buffers (see, e.g., the trace buffers 810, 812, and 814 of FIG. 8) to temporarily store the trace data while the network packet is being processed. In an illustrative example, when performance tracing of the network traffic through the HPC network 104 is enabled, the source endpoint node 102 is configured to generate a network packet and mark the network packet to indicate that trace data (i.e., network traffic data) is to be collected. After marking the network packet, the source endpoint node 102 transmits the network packet, including the trace data, to the network computing device 106.

Upon receiving the network packet, the network computing device 106 stores trace data extracted from the network packet, as well as, in some embodiments, header data (i.e., one or more header fields) of the network packet to a local trace buffer (see, e.g., the trace buffer 812 of the illustrative target endpoint node 108 of FIG. 8). Additionally, the network computing device 106 updates the trace data portion of the network packet with updated trace data, which the network computing device 106 then transmits to the target endpoint node 108. Upon receipt of the network packet at the target endpoint node 108, the target endpoint node 108 is configured to retrieve the trace data from the network packet and transmit the trace data to a local trace buffer of the target endpoint node 108 (see, e.g., the trace buffer 814 of the illustrative target endpoint node 108 of FIG. 8), which may then be further processed by the target endpoint node 108 and/or recorded to a trace memory of the target endpoint node 108 (see, e.g., the trace memory 818 of the illustrative target endpoint node 108 of FIG. 8).

It should be appreciated that while only a single network computing device 106 is shown in the illustrative system 100, the HPC network 104 may include a plurality of network computing devices 106 forming various paths/interconnects through which the network packet may be forwarded through the HPC network 104. Accordingly, it should be further appreciated that, depending on the architecture of the HPC network 104 and a flow of the network packet, the network packet may be transmitted through one or more network computing devices 106 before being forwarded to the target endpoint node 108.

The source endpoint node 102 may be embodied as any type of computation or computer device capable of performing the functions described herein, including, without limitation, a portable computing device (e.g., smartphone, tablet, laptop, notebook, wearable, etc.) that includes mobile hardware (e.g., processor, memory, storage, wireless communication circuitry, etc.) and software (e.g., an operating system) to support a mobile architecture and portability, a computer, a server (e.g., stand-alone, rack-mounted, blade, etc.), a network appliance (e.g., physical or virtual), a web appliance, a distributed computing system, a processor-based system, and/or a multiprocessor system.

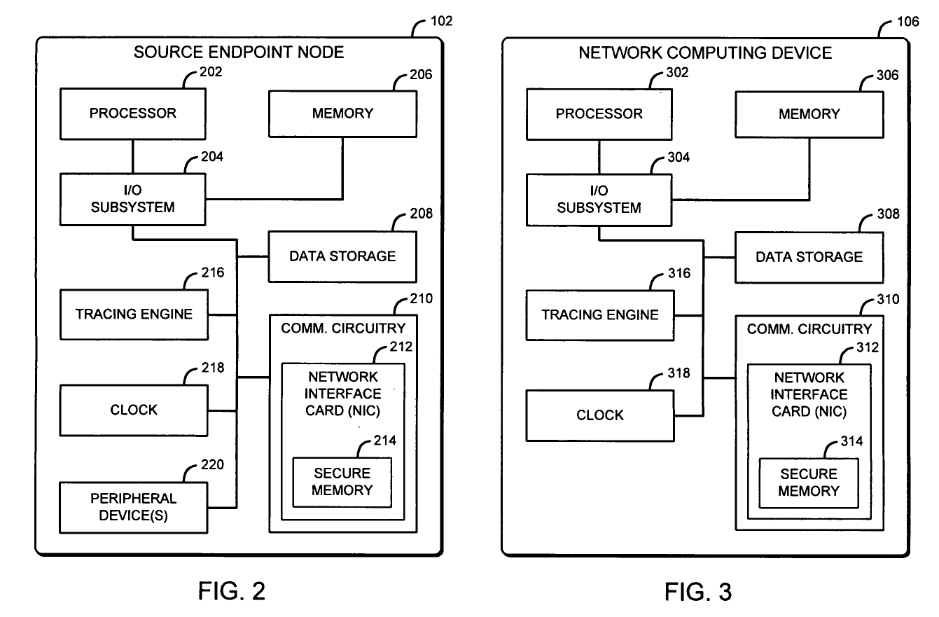

As shown in FIG. 2, the illustrative source endpoint node 102 includes a processor 202, an input/output (I/O) subsystem 204, a memory 206, a data storage device 208, communication circuitry 210, a tracing engine 216, a clock 218, and one or more peripheral devices 220. Of course, the source endpoint node 102 may include other or additional components, such as those commonly found in a computing device, in other embodiments. Additionally, in some embodiments, one or more of the illustrative components may be incorporated in, or otherwise form a portion of, another component. For example, the memory 206, or portions thereof, may be incorporated in the processor 202 in some embodiments. Further, in some embodiments, one or more of the illustrative components may be omitted from the source endpoint node 102.

The processor 202 may be embodied as any type of processor capable of performing the functions described herein. For example, the processor 202 may be embodied as a single or multi-core processor(s), digital signal processor, microcontroller, or other processor or processing/controlling circuit. Similarly, the memory 206 may be embodied as any type of volatile or non-volatile memory or data storage capable of performing the functions described herein. In operation, the memory 206 may store various data and software used during operation of the source endpoint node 102, such as operating systems, applications, programs, libraries, and drivers.

The memory 206 is communicatively coupled to the processor 202 via the I/O subsystem 204, which may be embodied as circuitry and/or components to facilitate input/output operations with the processor 202, the memory 206, and other components of the source endpoint node 102. For example, the I/O subsystem 204 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processor 202, the memory 206, and other components of the source endpoint node 102, on a single integrated circuit chip.

The data storage device 208 may be embodied as any type of device or devices configured for short-term or long-term storage of data such as, for example, memory devices and circuits, memory cards, hard disk drives, solid-state drives, or other data storage devices. It should be appreciated that the data storage device 208 and/or the memory 206 (e.g., the computer-readable storage media) may store various data as described herein, including operating systems, applications, programs, libraries, drivers, instructions, etc., capable of being executed by a processor (e.g., the processor 202) of the source endpoint node 102.

The communication circuitry 210 may be embodied as any communication circuit, device, or collection thereof, capable of enabling communications between the source endpoint node 102 and other computing devices (e.g., the network computing device 106, the target endpoint node 108, etc.) over a network (e.g., the HPC network 104). The communication circuitry 210 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication.

The illustrative communication circuitry 210 includes a network interface controller (NIC) 212, also commonly referred to as a host fabric interface (HFI) in such HPC networks 104. The NIC 212 may be embodied as one or more add-in-boards, daughtercards, network interface cards, controller chips, chipsets, or other devices that may be used by the source endpoint node 102. For example, in some embodiments, the NIC 212 may be integrated with the processor 202, embodied as an expansion card coupled to the I/O subsystem 204 over an expansion bus (e.g., PCI Express), part of a SoC that includes one or more processors, or included on a multichip package that also contains one or more processors. Additionally or alternatively, in some embodiments, functionality of the NIC 212 may be integrated into one or more components of the source endpoint node 102 at the board level, socket level, chip level, and/or other levels.

The illustrative NIC 212 includes a secure memory 214. The secure memory 214 of the NIC 212 may be embodied as any type of memory that is configured to securely store data local to the NIC 212. It should be appreciated that, in some embodiments, the NIC 212 may further include a local processor (not shown) local to the NIC 212. In such embodiments, the local processor of the NIC 212 may be capable of performing functions (e.g., replication, network packet processing, etc.) that may be offloaded to the NIC 212.

The tracing engine 216 may be embodied as any hardware, firmware, software, or combination thereof (e.g., limited-function high-speed hardware) capable of being configured by a processor (e.g., the processor 302) of the network computing device 106 and performing the various functions described herein, such as collecting performance-relevant data and making the performance-relevant data available for performance analysis to determine network performance characteristics. To do so, the tracing engine 216 is configured to interact with hardware blocks that generate the performance data (e.g., via performance counter hardware) related to network traffic and otherwise process the network packet. In some embodiments, the tracing engine 216 may form a portion of the processor 202 or otherwise may be established by a processor of the source endpoint node 102 (e.g., a processor (not shown) local to the NIC 212). In other embodiments, the tracing engine 216 may be embodied as an independent circuit or processor (e.g., a specialized co-processor or application specific integrated circuit (ASIC)). The tracing engine 216 is configured to manage trace data at the source endpoint node 102.

The trace data may include any type of information related to network traffic travelling through the HPC network 104, such as a timestamp recording a time of interest (e.g., a time of ingress, a time at which the network packet was queued, a time of egress, etc.), routing information (e.g., a source identifier, a destination identifier, etc.), delay information (e.g., an amount of time between queuing and egress, a number of cycles between ingress and egress, etc.), decision-making information (e.g., why the network packet was forwarded to a particular network computing device 106), information regarding one or more characteristics (e.g., a temperature, an internal buffer usage, a processor usage percentage, a memory usage, etc.) of one or more components of the device that generated, processed, forwarded, and/or received the network packet, etc.

To manage the trace data, the tracing engine 216 is configured to collect trace data related to a network packet generated at the source endpoint node 102 and insert the trace data into a network packet To do so, in some embodiments, the tracing engine 216 may store trace data in a local trace buffer of the source endpoint node 102 (see, e.g., the trace buffer 810 of the illustrative source endpoint node 102 of FIG. 8) and retrieve at least a portion of the trace data from the local trace buffer for insertion into the network packet. Additionally or alternatively, in some embodiments, the tracing engine 216 may generate trace data (e.g., an egress time) and directly insert such trace data into the network packet. In other words, some trace data may be generated on-demand and not stored in the local trace buffer. As such, it should be appreciated that the trace data management may be predicated or otherwise influenced by a state of the communication circuitry or progress of the communication circuitry in processing/forwarding the network packet.

In some embodiments, the tracing engine 216 may be configured to interpret a setting of the source endpoint node 102 that indicates whether to perform tracing of network traffic (i.e., whether to track trace data of network packets through the HPC network 104). In such embodiments, the tracing engine 216 may be further configured to update one or more bits of a header of network packets being transmitted from the source endpoint node 102 that indicate whether performance tracing of network traffic is enabled. It should be appreciated that additional and/or alternative information may be represented in the one or more bits of the header, such as a type of trace data to be collected, a size of the trace data to be collected (e.g., whether the trace data should be compressed), etc. It should be further appreciated that the information may instead be implemented as readable fields in the trace data.

In some embodiments, additional and/or alternative procedures may be implemented by the tracing engine 216 to enable network traffic performance tracing. For example, the additional and/or alternative procedures may include booting one or more of the source endpoint node 102, the network computing device 106, and the target endpoint node 108 into a tracing mode, phasing operation to adjust tracing at phase boundaries, and/or increasing or extending available header types that are not used for typical network packet transmission.

The clock 218 may be embodied as any software, hardware component(s), and/or circuitry from which a timestamp can be generated therefrom and is otherwise capable of performing the functions described herein. For example, in the illustrative embodiment, the clock 218 may be implemented via an on-chip oscillator. In some embodiments, the clock 218 may be shared (e.g., multiple distributed clocks being generally synchronized using a synchronization protocol).

The peripheral devices 220 may include any number of input/output devices, interface devices, and/or other peripheral devices. For example, in some embodiments, the peripheral devices 220 may include a display, a touch screen, graphics circuitry, a keyboard, a mouse, a microphone, a speaker, and/or other input/output devices, interface devices, and/or peripheral devices. The particular devices included in the peripheral devices 220 may depend on, for example, the type and/or intended use of the source endpoint node 102. The peripheral devices 220 may additionally or alternatively include one or more ports, such as a USB port, for example, for connecting external peripheral devices to the source endpoint node 102.

Referring again to FIG. 1, the HPC network 104, also commonly referred to as an HPC fabric, may be embodied as any type of HPC architecture capable of aggregating computing power in a manner such that advanced application programs can be run efficiently, reliably, and quickly. Unlike local area networks (LANs) and a wide area networks (WANs), which tend to have larger messages and packets, burstier operation (significant idle periods and significantly-frequent idle periods), and relatively long distances (where the speed of light limits some time constants which in turn constrain the design of long-haul networks), the HPC network 104 is configured to sustain very high rates of small-message traffic over short distances.

It should be appreciated that the source endpoint node 102 and/or the target endpoint node 108 may be connected to the HPC network 104 via another network, such as a wireless local area network (WLAN), a wireless personal area network (WPAN), a cellular network (e.g., Global System for Mobile Communications (GSM), Long-Term Evolution (LTE), etc.), a telephony network, a digital subscriber line (DSL) network, a cable network, a local area network (LAN), a wide area network (WAN), a global network (e.g., the Internet), or any combination thereof. In other words, the HPC network 104 may serve as a centralized network and, in some embodiments, may be communicatively coupled to another network (e.g., the Internet). Accordingly, the other network may include a variety of other network computing devices (e.g., virtual and physical routers, switches, network hubs, servers, storage devices, compute devices, etc.), as needed to facilitate communication between the source endpoint node 102 and the HPC network 104 and/or the target endpoint node 108 and the HPC network 104, which are not shown to preserve clarity of the description.

The network computing device 106 may be embodied as any type of network traffic processing and/or forwarding device capable of performing the functions described herein, such as, without limitation, a switch (e.g., rack-mounted, standalone, fully managed, partially managed, full-duplex, and/or half-duplex communication mode enabled, etc.), a server (e.g., stand-alone, rack-mounted, blade, etc.), a network appliance (e.g., physical or virtual), a router, a web appliance, a distributed computing system, a processor-based system, and/or a multiprocessor system. It should be appreciated, due to the demands for high speed of the HPC network 104 for which the network computing device 106 provides interconnects, that the network computing device 106 may have limited function, but include high-speed hardware (see, e.g., the tracing engine 316 described below) with which to parse header data and insert trace data.

The tracing engine 316 may be embodied as any hardware, firmware, software, or combination thereof (e.g., limited-function high-speed hardware) capable of being configured by a processor (e.g., the processor 302) of the network computing device 106 and performing the various functions described herein, such as collecting performance-relevant data and making the performance-relevant data available for performance analysis to determine network performance characteristics. The network performance characteristics may include any performance-related data that identifies a performance characteristic of the HPC network 104, as may be determined from the trace data at the target endpoint node 108, such as how full network computing device 102 queues are, the paths each traced network packet takes through the HPC network 104, how much time each network packet takes to travel to/through each network computing device 102, etc.

To collect the performance-relevant data, the tracing engine 316 is configured to interact with hardware blocks that generate the performance data (e.g., via performance counter hardware) related to network traffic and otherwise process the network packet. In some embodiments, the tracing engine 316 may form a portion of the processor 302 or otherwise may be established by a processor of the network computing device 102 (e.g., a processor (not shown) local to the NIC 312). In other embodiments, the tracing engine 316 may be embodied as an independent circuit or processor (e.g., a specialized co-processor or ASIC).

As shown in FIG. 3, similar to the illustrative source endpoint node 102 of FIG. 2, the illustrative network computing device 106 includes a processor 302, an I/O subsystem 304, a memory 306, a data storage device 308, communication circuitry 310 that includes a NIC 312 and a secure memory 314 of the NIC 312, a tracing engine 316, and a clock 318. As such, further descriptions of the like components are not repeated herein with the understanding that the description of the corresponding components provided above in regard to the illustrative source endpoint node 102 of FIG. 2 applies equally to the corresponding components of the illustrative network computing device 106 of FIG. 3.

Unlike existing software-only driven per-network packet tracing technologies, which do not typically provide visibility into the in-flight behavior of the network traffic through the HPC network 104, the tracing engine 316 is configured to trace individual network packets through the HPC network 104 at low time and space overhead. The tracing engine 316 of the network computing device 106, similar to the tracing engine 216 of the source endpoint node 102 described previously, is configured to insert trace data into a network packet to be forwarded from the network computing device 106. To do so, the tracing engine 316 is configured to generate trace data that may be stored local to the network computing device 106 for later retrieval and insertion or directly inserted into the trace data portion of the network packet.

The tracing engine 316 is further configured to extract trace data from a network packet received by the network computing device 106, such as may be received from the source endpoint node 102 or another network computing device 106. Additionally, the tracing engine 316 is configured to manage the local trace buffer of the network computing device 106 (see, e.g., the trace buffer 812 of the illustrative network computing device 106 of FIG. 8).

The tracing engine 316 is further configured to compress the trace data (i.e., reduce the size of the trace data), in some embodiments. For example, the tracing engine 316 may be configured to save routing information as an egress or ingress port/lane number (e.g., one of thirty-two) rather than a number identifying the network computing device 106. Accordingly, for any given path, the number identifying the network computing device 106 can be reconstructed from a sequence of port/lane numbers. Alternatively, the tracing engine 316 may be configured to save one bit indicating whether minimal or non-minimal routing is set, such as by using a Boolean value. In such embodiments, for a given source endpoint node 102 and a target endpoint node 108, the minimal route may be statically predictable.

Additionally or alternatively, the tracing engine 316 may be configured to save ingress-to-egress time (i.e., a time delta) rather than absolute time. In some embodiments, the tracing engine 316 may be configured to save time in ranges, or bins. For example, a range, or bin, may represent a number of consecutive cycle delays. In such embodiments, eight ranges may be encoded with 3 bits and can encode an arbitrary delay, albeit with reduced resolution, for example. Alternatively, the tracing engine 316 may be configured to save only data deemed to fall into a certain predetermined category. For example, the tracing engine 316 may be configured to support short and long trace entries (e.g., increment a counter by zero or one, increment the counter by one or two, etc.). In another example, network packets handled in a time less than a predetermined threshold duration may save trace data in short-form, while network packets handled in a time greater than a predetermined threshold duration (i.e., delayed network packets) may save trace data in long-form. In such embodiments, a counter may be saved or a change in one counter may be used to trigger saving of another counter.

Additionally or alternatively, trace data may be collected variably. For example, if one resource of the network computing device 106 could be a bottleneck or another resource of the network computing device 106 could be a bottleneck, then the tracing engine 316 may examine counters for each of the resources and collect trace data on only one of the resources, as well as a bit to indicate which resource was recorded. It should be appreciated that the network computing device 106 may be configured to collect additional other data in transit, such as various metrics of the network computing device 106, which may be stored by the tracing engine, inserted with the trace data in a network packet, and may be compressed in a similar fashion as the trace data described previously.

Similar to the source endpoint node 102, the target endpoint node 108 may be embodied as any type of computation or computer device capable of performing the functions described herein, including, without limitation, a portable computing device (e.g., smartphone, tablet, laptop, notebook, wearable, etc.) that includes mobile hardware (e.g., processor, memory, storage, wireless communication circuitry, etc.) and software (e.g., an operating system) to support a mobile architecture and portability, a computer, a server (e.g., stand-alone, rack-mounted, blade, etc.), a network appliance (e.g., physical or virtual), a web appliance, a distributed computing system, a processor-based system, and/or a multiprocessor system.

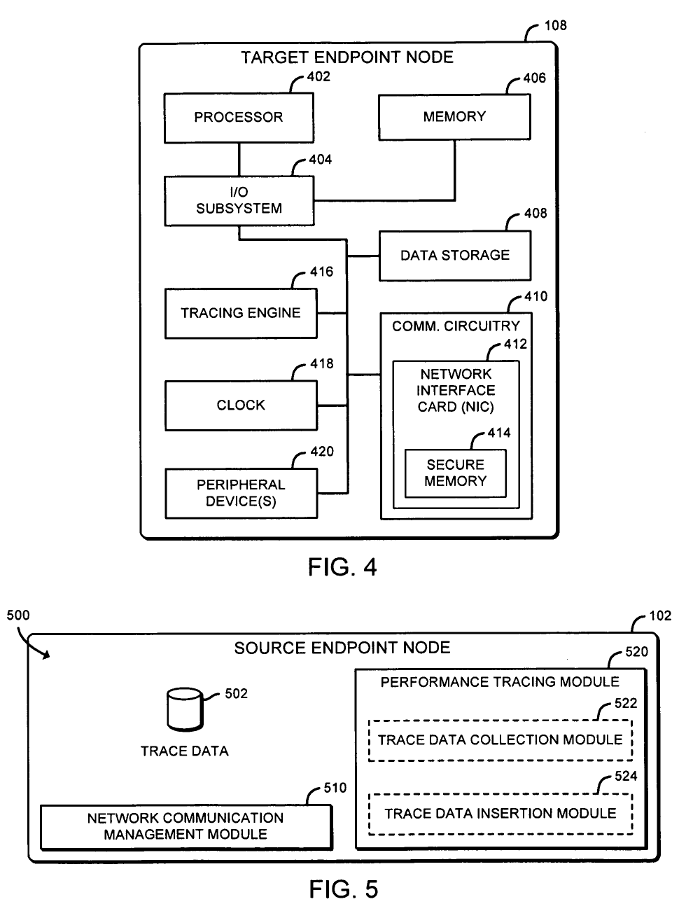

As shown in FIG. 4, the illustrative target endpoint node 108, similar to the illustrative source endpoint node 102 of FIG. 2, includes a processor 402, an input/output (I/O) subsystem 404, a memory 406, a data storage device 408, communication circuitry 410 that includes a NIC 412 and a secure memory 414 of the NIC 412, a tracing engine 416, a clock 418, and one or more peripheral devices 420. As such, further descriptions of the like components are not repeated herein with the understanding that the description of the corresponding components provided above in regard to the illustrative source endpoint node 102 of FIG. 2 applies equally to the corresponding components of the illustrative network computing device 106 of FIG. 3.

The tracing engine 416 of the target endpoint node 108, similar to the tracing engine 216 of the source endpoint node 102 previously described, is configured to retrieve locally stored trace data. The tracing engine 416 is further configured to extract trace data from a network packet received by the target endpoint node 108, such as may be received from the network computing device 106, and store the trace data locally. In some embodiments, the tracing engine 416 may be additionally configured to process the stored trace data and record it in a trace memory of the target endpoint node 108. Additionally or alternatively, in some embodiments, the tracing engine 416 may form a portion of the processor 402 or otherwise may be established by a processor of the target endpoint node 108 (e.g., a processor (not shown) local to the NIC 412). In other embodiments, the tracing engine 416 may be embodied as an independent circuit or processor (e.g., a specialized co-processor or application specific integrated circuit (ASIC)).

Referring now to FIG. 5, in an illustrative embodiment, the source endpoint node 102 establishes an environment 500 during operation. The illustrative environment 500 includes a network communication management module 510 and a performance tracing module 520. Each of the modules, logic, and other components of the environment 500 may be embodied as hardware, software, firmware, or a combination thereof. For example, each of the modules, logic, and other components of the environment 500 may form a portion of, or otherwise be established by, the processor 202, the communication circuitry 210 (e.g., the NIC 212), and/or other hardware components of the source endpoint node 102. As such, in some embodiments, one or more of the modules of the environment 500 may be embodied as circuitry or a collection of electrical devices (e.g., network communication management circuitry 510, performance tracing circuitry 520, etc.). It should be appreciated that the source endpoint node 102 may include other components, sub-components, modules, sub-modules, and/or devices commonly found in a computing device, which are not illustrated in FIG. 5 for clarity of the description.

The illustrative environment 500 of the source endpoint node 102 additionally includes trace data 502, which may be stored in the memory 214 and/or the data storage 216 of the source endpoint node 102, and may be accessed by the various modules and/or sub-modules of the source endpoint node 102. As described previously, the trace data 502 may include any type of information related to the flow of network traffic, such as route information, delay information, queue information, decision-making information, etc., as well as any characteristics of one or more components of the source endpoint node 102 (e.g., temperature, internal buffer usage, processor usage, memory usage, etc.) that processed/forwarded the network packet.

The network communication management module 510 is configured to facilitate inbound and outbound network communications (e.g., network traffic, network packets, network flows, etc.) to and from the source endpoint node 102. To do so, the network communication management module 510 is configured to receive and process network packets from other computing devices (e.g., the network computing device 106). Additionally, the network communication management module 510 is configured to prepare and transmit network packets to another computing device (e.g., the network computing device 106). Accordingly, in some embodiments, at least a portion of the functionality of the network communication management module 510 may be performed by the communication circuitry 210, and more specifically by the NIC 212.

The performance tracing module 520 is configured to manage trace data stored local to the source endpoint node 102 and/or generated by the source endpoint node 102, as well as insert such trace data into a network packet generated by the source endpoint node 102. To do so, in some embodiments, the performance tracing module 520 may include a trace data collection module 522 configured to generate and/or retrieve trace data for insertion into the network packet. In some embodiments, the trace data collection module 522 configured to retrieve the trace data from the trace data 502, such as may be stored in a local trace buffer (see, e.g., the trace buffer 810 of FIG. 8 local to the NIC 212). Additionally or alternatively, in some embodiments, the performance tracing module 520 may include a trace data insertion module 524 configured to insert the retrieved trace data into the network packet, such as a portion of the network packet assigned to store the trace data. It should be appreciated that, in some embodiments, at least a portion of the functions of the performance tracing module 520 described herein may be performed by the tracing engine 216 described above.

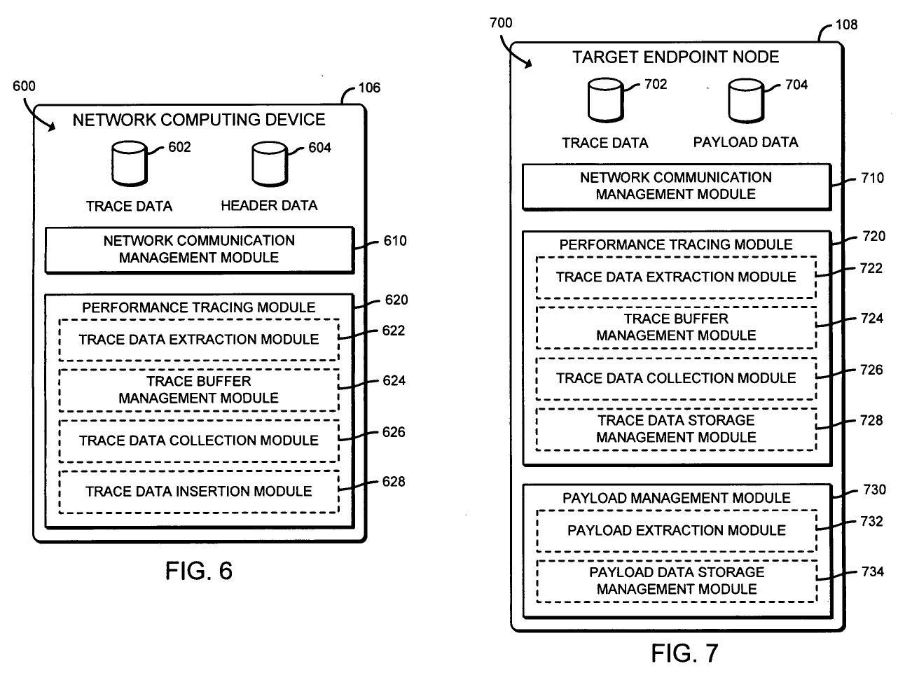

Referring now to FIG. 6, in an illustrative embodiment, the network computing device 106 establishes an environment 600 during operation. The illustrative environment 600 includes a network communication management module 610 and a performance tracing module 620. Each of the modules, logic, and other components of the environment 600 may be embodied as hardware, software, firmware, or a combination thereof. For example, each of the modules, logic, and other components of the environment 600 may form a portion of, or otherwise be established by, the processor 302, the communication circuitry 310 (e.g., the NIC 312), and/or other hardware components of the network computing device 106. As such, in some embodiments, one or more of the modules of the environment 600 may be embodied as circuitry or a collection of electrical devices (e.g., network communication management circuitry 610, performance tracing circuitry 620, etc.). It should be appreciated that the network computing device 106 may include other components, sub-components, modules, sub-modules, and/or devices commonly found in a computing device, which are not illustrated in FIG. 6 for clarity of the description.

The illustrative environment 600 of the network computing device 106 additionally includes trace data 602 and header data 604, each of which may be stored in the memory 314 and/or the data storage 316, and may be accessed by the various modules and/or sub-modules of the network computing device 106. As described previously, the trace data 602 may include any type of information related to the flow of network traffic, such as route information, delay information, queue information, decision-making information, etc., as well as any characteristics of one or more components of the source endpoint node 102 and/or the network computing device(s) 106 (e.g., temperature, internal buffer usage, processor usage, memory usage, etc.) that processed/forwarded the network packet.

The network communication management module 610, similar to the network communication management module 510 of FIG. 5, is configured to facilitate inbound and outbound network communications (e.g., network traffic, network packets, network flows, etc.) to and from the network computing device 106. To do so, the network communication management module 610 is configured to receive and process network packets from other computing devices (e.g., the source endpoint node 102, the target endpoint node 108, another network computing device 106, etc.). Additionally, the network communication management module 610 is configured to prepare and transmit network packets to another computing device (e.g., the source endpoint node 102, the target endpoint node 108, another network computing device 106, etc.). Accordingly, in some embodiments, at least a portion of the functionality of the network communication management module 610 may be performed by the communication circuitry 310, and more specifically by the NIC 312.

The performance tracing module 620 is configured to manage trace data stored local to the network computing device 106 and/or generated by the network computing device 106, as well as insert such trace data into a network packet generated by the source endpoint node 102. To do so, in some embodiments, the performance tracing module 620 may include a trace data extraction module 622 configured to extract trace data from a network packet (e.g., from a designated portion of the network packet) and a trace buffer management module 624 configured to store the extracted trace data (e.g., the trace data 602) at a local trace buffer (see, e.g., the trace buffer 812 of FIG. 8 local to the NIC 312). Additionally, in some embodiments, the performance tracing module 620 may include a trace data collection module 626 configured to generate and/or retrieve trace data for insertion into the network packet. In some embodiments, the trace data collection module 626 may be configured to retrieve trace data from the trace data 602. Additionally or alternatively, in some embodiments, the performance tracing module 620 may include a trace data insertion module 628 configured to insert the retrieved trace data into the network packet, such as in a portion of the network packet designated for storing the trace data (see, e.g., the trace data portion 804 of FIG. 8). It should be appreciated that, in some embodiments, at least a portion of the functions of the performance tracing module 620 described herein may be performed by the tracing engine 316 of the network computing device 106.

Referring now to FIG. 7, in an illustrative embodiment, the target endpoint node 108 establishes an environment 700 during operation. The illustrative environment 700 includes a network communication management module 710, a performance tracing module 720, and a payload management module 730. Each of the modules, logic, and other components of the environment 700 may be embodied as hardware, software, firmware, or a combination thereof. For example, each of the modules, logic, and other components of the environment 700 may form a portion of, or otherwise be established by, the processor 402, the communication circuitry 410 (e.g., the NIC 412), and/or other hardware components of the target endpoint node 108. As such, in some embodiments, one or more of the modules of the environment 700 may be embodied as circuitry or a collection of electrical devices (e.g., network communication management circuitry 710, performance tracing circuitry 720, payload management circuitry 730, etc.). It should be appreciated that the target endpoint node 108 may include other components, sub-components, modules, sub-modules, and/or devices commonly found in a computing device, which are not illustrated in FIG. 7 for clarity of the description.

The illustrative environment 700 of the target endpoint node 108 additionally includes trace data 702 and payload data 704, each of which may be accessed by the various modules and/or sub-modules of the target endpoint node 108. Further, each of the trace data 702 and payload data 704 may be stored in the memory 414 and/or the data storage 416. As described previously, the trace data 702 may include any type of information related to the flow of network traffic, such as route information, delay information, queue information, decision-making information, etc., as well as any characteristics of one or more components of the target endpoint node 108 (e.g., temperature, internal buffer usage, processor usage, memory usage, etc.) of the source endpoint node 102, the network computing device(s) 106, and/or target endpoint node 108 that processed/forwarded the network packet.

The network communication management module 710, similar to the network communication management modules 510 and 610 of FIGS. 5 and 6, respectively, is configured to facilitate inbound and outbound network communications (e.g., network traffic, network packets, network flows, etc.) to and from the target endpoint node 108. To do so, the network communication management module 710 is configured to receive and process network packets from other computing devices (e.g., the network computing device 106). Additionally, the network communication management module 710 is configured to prepare and transmit network packets to another computing device (e.g., the network computing device 106). Accordingly, in some embodiments, at least a portion of the functionality of the network communication management module 710 may be performed by the communication circuitry 410, and more specifically by the NIC 412.

The performance tracing module 720 is configured to manage trace data stored local to the target endpoint node 108 and/or generated by the target endpoint node 108. To do so, in some embodiments, the performance tracing module 620 may include a trace data extraction module 722 configured to extract trace data from a network packet (e.g., from a trace data portion of the network packet), a trace buffer management module 724 configured to store the extracted trace data at a local trace buffer (see, e.g., the trace buffer 814 of FIG. 8 local to the NIC 412), a trace data collection module 726 configured to generate and/or retrieve trace data for insertion into the network packet, and a trace data storage management module 728 configured to store trace data from the local trace buffer into a memory location external to the NIC 412. It should be appreciated that, in some embodiments, at least a portion of the functions of the performance tracing module 720 described herein may be performed by the tracing engine 416 of the target endpoint node 108.

The payload management module 730 is configured to manage payloads of the network packets received by the target endpoint node 108. To do so, in some embodiments, the payload management module 730 may include a payload extraction module 732 to extract the payloads from the received network packets and a payload data storage management module 734 to manage the storage of the extracted payloads to a memory local to the target endpoint node 108 (see, e.g., the application memory 816 of the illustrative target endpoint node 108 of FIG. 8).

Referring now to FIG. 8, in use, the source endpoint node 102 is configured to generate a network packet 800 that includes a header portion 802, a trace data portion 804, and a payload portion 806. The source endpoint node 102 is additionally configured to generate trace data and/or retrieve trace data from a trace buffer 810 in the secure memory 214 of the NIC 212 and insert the generated/retrieved trace data into the trace data portion 804. The trace data in the trace data portion 804 of the network packet 800 inserted by the source endpoint node 102 may include one or more times of interest (e.g., when the network packet 800 was queued by software of the source endpoint node 102, a time of egress from the source endpoint node 102, etc.), counters (e.g., a hop counter incremented at every network computing device 106 the network packet 800 is forwarded to), an indicator to indicate where to write the trace data in the network packet 800 (e.g., a trace data location indicator to indicate a location in the trace data portion 804 at which the network computing device 106 is to write its trace data), and an indicator to indicate a maximum size of the field/location in which the network computing device 106 is to insert its trace data into the trace data portion 804 (e.g., a trace data size indicator).

In some embodiments, the source endpoint node 102 may be further configured to insert an indicator into the network packet 800 that indicates trace data is included in the network packet 800 and/or that trace data is to be tracked throughout the flow of the network packet 800 through the HPC network 104 (i.e., at each target of the network packet 800 through the HPC network 104). In such embodiments, the indicator may be included in the header portion 802 of the network packet 800.

It should be appreciated that, in some embodiments, no trace data may be collected at one or more of the source endpoint node 102, the network computing device 106, and the target endpoint node, such as when performance tracing is not enabled for a particular network packet. In such embodiments, the trace data portion 804 of the network packet 800 may be empty, excluded, or otherwise left unchanged.

It should be further appreciated that, in some embodiments, the header portion 802 and/or payload portion 806 of the network packet 800 may include redundant information usable for error detection (e.g., cyclic redundancy check (CRC), checksum, etc.). In such embodiments, the redundant information is typically not modified while the network packet 800 is in-flight, such that the network packet 800 does not need to be recomputed, which can introduce overhead, latency, etc. Accordingly, in some embodiments, the trace data portion 804 may be excluded from the error detection calculations, such that adding/modifying trace data in the trace data portion 804 does not change the error detection calculations for the header portion 802 and/or payload portion 806 of the network packet 800. However, in some embodiments, the trace data portion 804 may be separately protected by a separate error detection technology may be used, such as using a weaker form of CRC that may provide less error protection but reduced overhead or protecting individual fields within the trace data portion 804 (e.g., using the weaker form of CRC).

The network computing device 106 is configured to receive the network packet 800 from the source endpoint node 102 or another network computing device 106, generate any applicable trace data, and insert the generated trace data into the trace data portion 804 of the network packet 800. It should be appreciated that the network computing device 106 may be configured to determine whether the network packet 800 includes a trace data portion 804 prior to trace data generated, such as may be indicated via a field in the header portion 802 of the network packet 800, prior to attempting to extract the trace data. Additionally, the network computing device 106 is configured to extract the trace data from the trace data portion 804 (e.g., based on the write location and/or max size indicators), and store the extracted trace data to a trace buffer 812 in the secure memory 314 local to the NIC 312. Accordingly, in such embodiments, the network computing device 106 is further configured to retrieve trace data from the trace buffer 812 and insert the retrieved trace data into the trace data portion 804 of the network packet 800.

The trace data inserted by the network computing device 106 may include any type of information related to the network packet 800 travelling through the HPC network 104, such as transit information, queue information, credit availability, error rate counters, other event counters (e.g., low bits of the event counters), routing decision information (e.g., a selected routing path), information relating to a detected cause of delay (e.g., delayed due to credit exhaustion, port availability bottleneck, etc.), and/or characteristic(s) of components of the network computing device 106 (e.g., a temperature, an internal buffer usage information, a processor usage percentage, a memory usage percentage, etc.). The trace data may additionally include a type indicator indicating what type of trace data and/or what format to store the trace data.

Additionally or alternatively, the trace data may include an identifying indicator, such as may be managed by one or more counters that are incremented at every network computing device 106 the network packet is forwarded to (e.g., a hop counter). In other words, the trace data may be paired with the counter value at a particular network computing device 106 and stored in the trace data portion, such that the target endpoint node 108 can determine a path and associate the trace data with the network computing devices 106 of the path. In such embodiments, the counter value may be paired with a time of interest (e.g., a time of ingress of the network packet 800 at the network computing device 106, a time for which the network packet 800 was queued at the network computing device 106, a time of egress of the network packet 800 from the network computing device 106, etc.) or other information related to the network packet 800 travelling through the HPC network 104 as described previously. The network computing device 106 is further configured to forward the network packet 800 to either another network computing device 106 or the target endpoint node 108, depending on a determined flow of the network packet 800.

The target endpoint node 108 is configured to receive the network packet 800 from the network computing device 106, extract the trace data from the trace data portion 804 (e.g., based on the write location and/or max size indicators), and store the extracted trace data to a trace buffer 814 in the secure memory 414 local to the NIC 412. Additionally, the target endpoint node 108 is configured to store the trace data from the trace buffer 814 to a trace memory 818 (i.e., a stable storage location) external to the NIC 412. It should be appreciated that storing the trace data to the trace memory 818 frees at least a portion of the trace memory 818, which may allow for additional trace data to be saved. The target endpoint node 108 is further configured to extract a payload from the payload portion 806 of the network packet and store the extracted payload into an application memory 816 external to the NIC 412.

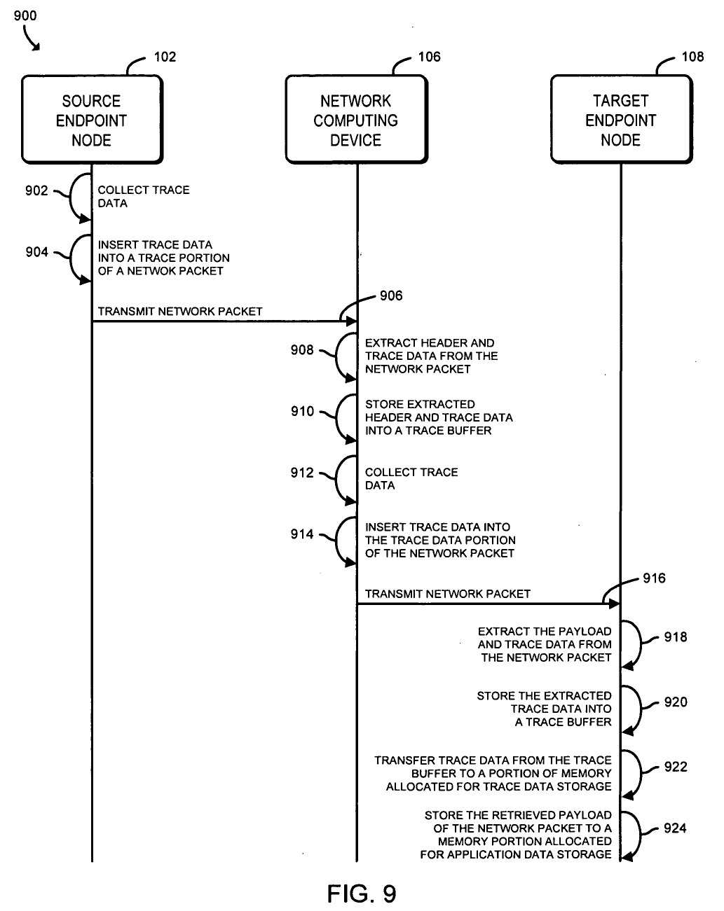

Referring now to FIG. 9, an embodiment of a communication flow 900 for network traffic performance tracing includes the source endpoint node 102, the network computing device 106, and the target endpoint node 108. The illustrative communication flow 900 includes a number of data flows, some of which may be executed separately or together, depending on the embodiment. It should be appreciated that at least a portion of the data flows described herein may be performed by the tracing engine of the respective computing device (i.e., the tracing engine 216 of the source endpoint node 102, the tracing engine 316 of the network computing device 106, and the tracing engine 416 of the target endpoint node 108). In data flow 902, the source endpoint node 102 collects trace data. To do so, the source endpoint node 102 may generate the trace data (i.e., to be directly inserted, not stored) and/or retrieve previously generated trace data from a trace buffer local to the NIC 212. In data flow 904, the source endpoint node 102 inserts the retrieved trace data into a trace portion of a network packet generated by the source endpoint node 102. In data flow 906, the source endpoint node 102 transmits the network packet, including the trace data, to the network computing device 106.

In data flow 908, the network computing device 106 extracts header and trace data from the network packet transmitted to the network computing device 106 in data flow 906. In data flow 910, the network computing device 106 stores the extracted header and trace data into a trace buffer local to the network computing device 106. It should be appreciated that source and destination computing devices are typically encoded into a field of the header of the network packet. As such, rather than encoding such information in the trace data, such information may be extracted from the appropriate header fields and saved alongside the trace data. As a result, additional pertinent data related to the trace data may be saved without increasing the size of the network packet (i.e., without bloating the trace data portion of the network packet). It should be further appreciated that, in some embodiments, the trace data is not extracted from the network packet. As such, in some embodiments, at least a portion of the data flows 908 and 910 may be skipped.

In data flow 912, the network computing device 106 collects trace data. To do so, as described previously, the network computing device 106 may generate trace data and/or retrieve trace data from the trace buffer. In data flow 914, the network computing device 106 inserts the collected trace data into a trace data portion of the network packet. It should be appreciated that the network computing device 106 may be configured to perform an analysis on the trace data in the trace buffer (e.g., to condense or otherwise compress the trace data) prior to being inserted into the trace data portion of the network packet. Additionally or alternatively, in network architectures designed for high throughput of messages (e.g., HPC fabrics), messages may use cut-through implementations in which a network packet ingress into the network computing device 106 and egress from the network computing device 106 occur near simultaneously (i.e., only a few cycle delay in the network computing device 106). In such implementations, packet inspection and decision processing may be required prior to processing data of the network packet (i.e., serialization), which can introduce overhead, latency, etc.

To minimize serialization, the network computing device 106 may be configured to reduce or altogether remove overhead associated with serialization, such as by allocating space (i.e., a trace data portion) in the network packet prior to transmission of the network packet to the network computing device 106 from the source endpoint node 102, including a position indicator in a header field of the network packet that identifies where the trace data portion is written to or is to be written to in the network packet, incrementing the position indicator unconditionally into the egressing network packet to minimize delay, and/or including a maximum size indicator in a header field of the network packet that controls a size of the trace data and/or whether any trace data is written into the trace data portion of the network packet.

In data flow 916, the network computing device 106 transmits the network packet to the target endpoint node 108. It should be appreciated that, in some embodiments, the network computing device 106 may forward the network packet through one or more other network computing devices 106 prior to the network packet being forwarded to the target endpoint node 108. In data flow 918, the target endpoint node 108 extracts the payload and trace data from the network packet that was received from the network computing device 106 in data flow 916. In data flow 920, the target endpoint node 108 stores the extracted trace data into a trace buffer of the target endpoint node 108. It should be appreciated that additional trace data may be generated by the target endpoint node 108 (i.t., not extracted from the trace data portion of the network packet), such as an ingress time. Accordingly, such trace data may also be stored in the trace buffer of the target endpoint node 108. In data flow 922, the target endpoint node 108 stores the trace buffer data to a portion of memory of the target endpoint node 108 (e.g., the memory 406) allocated for trace data storage. In data flow 924, the target endpoint node 108 stores the extracted payload data to a portion of memory of the target endpoint node 108 (e.g., the memory 406) allocated for storage of application data.

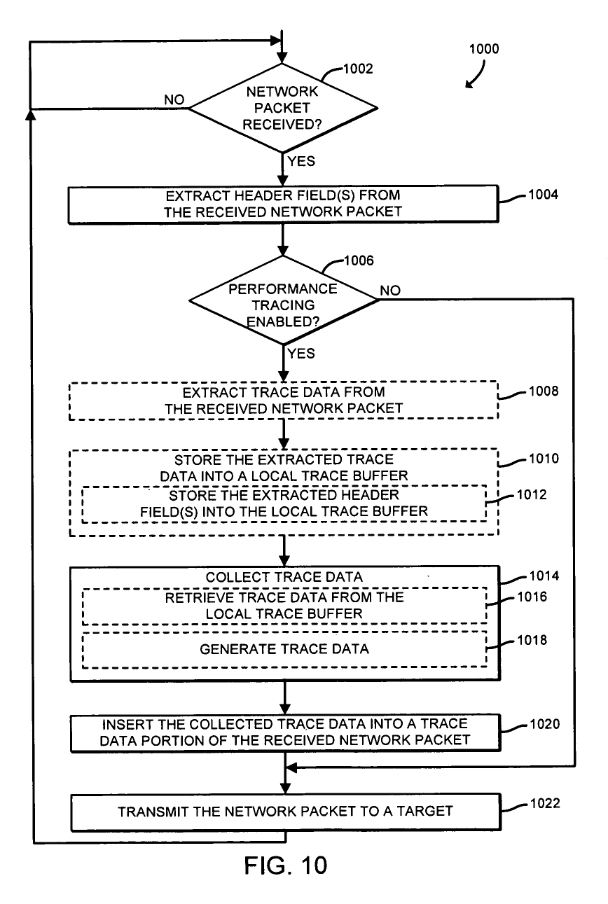

Referring now to FIG. 10, in use, the network computing device 106 may execute a method 1000 for inserting trace data into a network packet. It should be appreciated that at least a portion of the method 1000 may be executed by the NIC 312 of the network computing device 106 or otherwise performed by the tracing engine 316 of the network computing device 106. It should be further appreciated that, in some embodiments, the method 1000 may be embodied as various instructions stored on a computer-readable media, which may be executed by the processor 302, the NIC 312, and/or other components of the network computing device 106 to cause the network computing device 106 to perform the method 1000. The computer-readable media may be embodied as any type of media capable of being read by the network computing device 106 including, but not limited to, the memory 306, the data storage device 308, the secure memory 314 of the NIC 312, other memory or data storage devices of the network computing device 106, portable media readable by a peripheral device of the network computing device 106, and/or other media.

The method 1000 begins with block 1002, in which the network computing device 106 determines whether a network packet has been received, such as may be received from the source endpoint node 102 or another network computing device 106. If so, the method 1000 advances to block 1004, wherein the network computing device 106 extracts one or more header fields from the network packet received in block 1002. In block 1006, the network computing device 106 determines whether performance tracing is enabled, such as may be determined from a trace data indicator located in one or more of the header fields extracted in block 1004 (e.g., a trace bit). As described previously, the trace data indicator may indicate whether performance tracing is enabled, a type of trace data to collect, a size of the trace data to collect, etc. If the trace data indicator was not detected, or the trace data indicator otherwise indicates not to collect trace data (i.e., performance tracing is disabled), the method 1000 branches to block 1022, wherein the network computing device 106 transmits the network packet to a target (e.g., another network computing device 106 or the target endpoint node 108).

Otherwise, if performance tracing is enabled, the method 1000 advances from block 1006 to block 1008. In some embodiments, in block 1008 the network computing device 106 may extract trace data from the received network packet. In such embodiments, in block 1010, the network computing device 106 may store the extracted trace data into a local trace buffer (e.g., the trace buffer 812 of FIG. 8). In some embodiments, all of the extracted trace data may be saved, while in other embodiments, only a portion of the trace data may be saved. In some embodiments, in block 1012, the network computing device 106 additionally stores one or more of the header fields extracted in block 1004, such as to provide context for the stored trace data. Additionally, in some embodiments, the network computing device 106 may store at least a portion of the header field(s) extracted in block 1004.

As described previously, the trace data may include any type of information related to network traffic travelling through the HPC network 104, such as routing information, delay information, reception/transmission queue information, decision-making information, information regarding one or more characteristics of one or more components of the network computing device 106 (e.g., temperature, internal buffer usage, processor usage, memory usage, etc.) that processed/forwarded the network packet, etc. As also described previously, the trace data may additionally include a location of the trace data (i.e., the trace data portion of the network packet) and/or a maximum size indicator may be stored in a header field of the network packet, such that the indicators may be used to extract the trace data from the trace data portion of the network packet, as well as one or more counters, such as a hop counter that is incremented at every network computing device 106 the network packet is forwarded to.

In block 1014, the network computing device 106 collects trace data. To do so, in block 1016, the network computing device 106 retrieves trace data from the local trace buffer. It should be appreciated that the trace data retrieved from the local trace buffer may include additional trace data and/or updated trace data. It should be further appreciated that the trace data retrieved from the local trace buffer may be adjusted on a per-network packet bases. For example, an application, a performance tool, a selective mechanism, etc., at the source endpoint node 102 may indicate to the network computing device 106 that some network packets (e.g., based on a flow, a source indicator, a destination indicator, etc.) are to be traced at a higher level, while other network packets are to be traced at a reduced level or not at all (e.g., acknowledgement network packets, network packets generated to handle errors in other network packets, etc.). Accordingly, the trace data retrieve for one network packet may be different than trace data retrieved for another network packet. It should be appreciated that the trace data retrieved for one network packet may be based on a previous or other network packet. As described previously, in some embodiments, trace data may be generated for direct insertion into the trace data portion of the network packet (i.e., not stored in the local trace buffer). In such embodiments, in block 1018, the network computing device 106 generates the trace data to be collected.

In block 1020, the network computing device 106 inserts the trace data collected in block 1014 into a portion of the network packet dedicated to the trace data (i.e., a trace data portion of the network packet, such as may be determined from the location/size indicator in the trace data portion of the network packet). In block 1022, the network computing device 106 transmits the network packet to a target (e.g., another network computing device 106 or the target endpoint node 108) before the method 1000 returns to block 1002 to determine whether another network packet has been received.

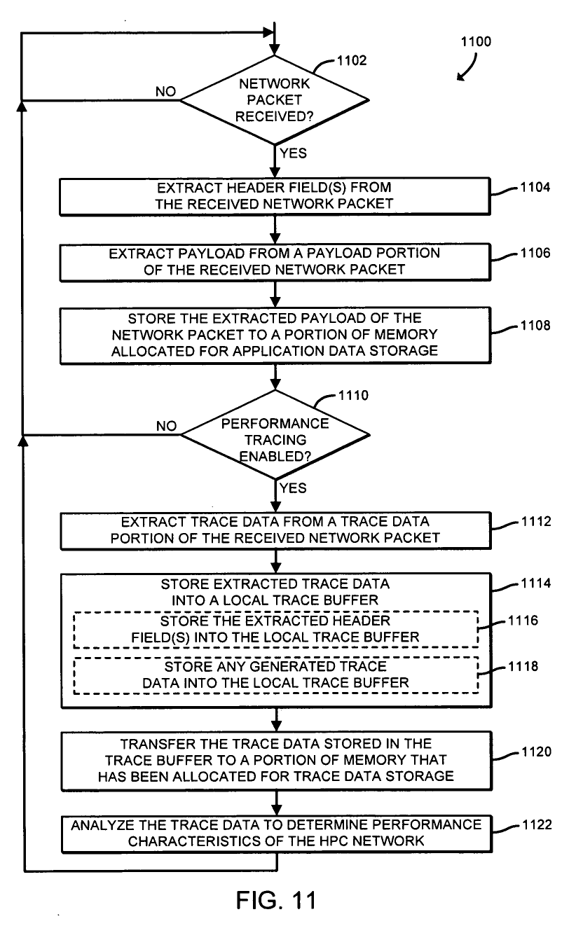

Referring now to FIG. 11, in use, the target endpoint node 108 may execute a method 1100 for storing trace data of a network packet. It should be appreciated that at least a portion of the method 1100 may be executed by the NIC 412 of the target endpoint node 108 or otherwise performed by the tracing engine 416 of the target endpoint node 108. It should be further appreciated that, in some embodiments, the method 1100 may be embodied as various instructions stored on a computer-readable media, which may be executed by the processor 402, the NIC 412, and/or other components of the target endpoint node 108 to cause the target endpoint node 108 to perform the method 1100. The computer-readable media may be embodied as any type of media capable of being read by the target endpoint node 108 including, but not limited to, the memory 406, the data storage device 408, the secure memory 414 of the NIC 412, other memory or data storage devices of the target endpoint node 108, portable media readable by a peripheral device of the target endpoint node 108, and/or other media.

The method 1100 begins with block 1102, in which the target endpoint node 108 determines whether a network packet has been received, such as may be received from the network computing device 106. If so, the method 1100 advances to block 1104, wherein the target endpoint node 108 extracts one or more header fields from the network packet received in block 1102. In block 1106, the target endpoint node 108 extracts the payload from a payload portion of the received network packet. In block 1108, the target endpoint node 108 stores the payload of the network packet extracted in block 1106 to a portion of memory (e.g., the application memory 816 of FIG. 8) allocated for application data storage before the method returns to block 1102 to determine whether another network packet has been received.

In block 1110, the target endpoint node 108 determines whether performance tracing is enabled, such as may be determined from a trace data indicator located in one or more of the header fields extracted in block 1104. As described previously, the trace data indicator may indicate whether performance tracing is enabled, a type of trace data to collect, a size of the trace data to collect, etc. If the trace data indicator was not detected, or the trace data indicator otherwise indicates not to collect trace data (i.e., performance tracing is disabled), the method 1100 returns to block 1102, wherein the target endpoint node 108 determines whether another network packet has been received.

Otherwise, if performance tracing is enabled, the method 1100 advances from block 1110 to block 1112, in which the target endpoint node 108 extracts trace data from a trace data portion of the received network packet. As described previously, the trace data may include any type of information related to network traffic travelling through the HPC network 104, such as routing information, delay information, reception/transmission queue information, decision-making information, information regarding one or more characteristics of one or more components of the network computing device 106 (e.g., temperature, internal buffer usage, processor usage, memory usage, etc.) that processed/forwarded the network packet, etc.

As also described previously, the trace data may include a location indicator that indicates a location in the trace data portion of the network packet at which the network computing device 106 is to store its trace data. Additionally, as also described previously, the trace data may include a maximum size indicator that indicates a maximum size of the trace data to be inserted by the network computing device 106, the start of which may be based on the location indicator. The trace data may additionally include a type indicator indicating what type of trace data and/or what format to store the trace data, and/or an identifying indicator, such as may be managed by one or more counters that are incremented at every network computing device 106 the network packet is forwarded to (e.g., a hop counter). In other words, the trace data may be paired with the counter value at a particular network computing device 106 and stored in the trace data portion, such that the target endpoint node 108 can determine a path and associate the trace data with the network computing devices 106 of the path.

In block 114, the target endpoint node 108 stores the extracted trace data into a local trace buffer. In some embodiments, all of the extracted trace data may be saved, while in other embodiments, only a portion of the trace data may be saved. In other words, in some embodiments, the target endpoint node 108 may discard at least a portion of the trace data extracted in block 1106 without writing to memory or compress the trace data such that only a portion of the trace data is saved. In such embodiments, the target endpoint node 108 may determine what trace data to save based on a random control feature, an identifier of the source endpoint node 102, a particular range of timestamps, values contained in the trace data (e.g., a value that indicated to only trace network packets with a delivery time that exceeds a predefined threshold). In some embodiments, the target endpoint node 108 may save the trace data to memory in a circular buffer (i.e., overwriting older trace data that has not been consumed). Alternatively, in some embodiments, the target endpoint node 108 may save the trace data until a memory buffer is filled, in which case the target endpoint node 108 stops saving trace data to avoid overwriting older trace data contained in the memory buffer.

In some embodiments, in block 1116, the target endpoint node 108 additionally stores one or more of the header fields extracted in block 1104 with the stored trace data, such as to provide context for the stored trace data. As described previously, in some embodiments, the target endpoint node 108 may generate additional trace data not included in the network packet, such as an ingress time. In such embodiments, in block 1118, the target endpoint node 108 may additionally store any trace data generated by the target endpoint node 108 subsequent to having received the network packet at the target endpoint node 108 into the local trace buffer.

In block 1120, the target endpoint node 108 transfers the trace data from the local trace buffer into a portion of memory (e.g., the trace memory 818) that has been allocated for trace data storage external to the trace buffer and the NIC 412. It should be appreciated that the trace data retrieved from the local trace buffer may include additional trace data and/or updated trace data. For example, the target endpoint node 108 may determine a trip time between the source endpoint node 102 and the target endpoint node 108 based on a timestamp generated at the time of ingress at the target endpoint node 108 and another timestamp generated at the time of egress from the source endpoint node 102 that is stored in the trace data.

In block 1122, the target endpoint node 108 analyzes the trace data to determine one or more network performance characteristics of the HPC network 104. As described previously, the network performance characteristics may include delay information, paths of each of the traced network packets, queue fullness at each network computing device 102 in the path, durations of time each of the traced network packets spend at each network computing device 102 in the path, and/or any other data related to the performance of the network traffic through the HPC network 104. As such, based on the network performance characteristics, various issues of the HPC network 104 may be detected and the network computing device(s) 106 responsible for the detected issues may be identified.

### EXAMPLES

Illustrative examples of the technologies disclosed herein are provided below. An embodiment of the technologies may include any one or more, and any combination of, the examples described below.

Example 1 includes a network computing device for tracing network performance, the network computing device comprising one or more processors; and one or more data storage devices having stored therein a plurality of instructions that, when executed by the one or more processors, cause the network computing device to receive a network packet from a source endpoint node, wherein the network packet includes a header and a trace data portion; generate trace data corresponding to the received network packet; update the trace data portion of the network packet to include the generated trace data from the trace buffer of the network computing device; and transmit the updated network packet to a target endpoint node, wherein the updated network packet is usable to determine one or more network performance characteristics.

Example 2 includes the subject matter of Example 1, and wherein the trace data portion includes trace data of the source endpoint node.

Example 3 includes the subject matter of any of Examples 1 and 2, and wherein the plurality of instructions further cause the network computing device to extract at least a portion of the trace data from the trace data portion of the network packet; and store the extracted portion of trace data to a trace buffer of the network computing device.

Example 4 includes the subject matter of any of Examples 1-3, and wherein the plurality of instructions further cause the network computing device to retrieve the stored portion of the trace data from the trace buffer, wherein to update the trace data portion of the network packet comprise to update the trace data portion of the network packet with the retrieved portion of the trace data.

Example 5 includes the subject matter of any of Examples 1-4, and wherein the plurality of instructions further cause the network computing device to extract at least a portion of the trace data from the trace data portion of the network packet; and store the extracted portion of trace data to a trace buffer of the network computing device.

Example 6 includes the subject matter of any of Examples 1-5, and wherein the plurality of instructions further cause the network computing device to extract at least a portion of the header of the network packet; and store the extracted portion of the header to a trace buffer of the network computing device.

Example 7 includes the subject matter of any of Examples 1-6, and wherein the plurality of instructions further cause the network computing device to parse the header of the network packet to retrieve an indicator inserted by the source endpoint node; and determine whether the indicator indicates to collect trace data, wherein to store the trace data of the network packet to the trace buffer of the network computing device comprises to store the trace data subsequent to a determination that the indicator indicates to collect trace data.

Example 8 includes the subject matter of any of Examples 1-7, and wherein the plurality of instructions further cause the network computing device to identify a type of the trace data to be collected based on the indicator, wherein to generate the trace data is based on the type of the trace data to be collected.

Example 9 includes the subject matter of any of Examples 1-8, and wherein the plurality of instructions further cause the network computing device to identify a size of the trace data to be collected based on the indicator, wherein to generate the trace data is based on the size of the trace data to be collected.

Example 10 includes the subject matter of any of Examples 1-9, and wherein the plurality of instructions further cause the network computing device to generate trace data for direct insertion into the trace data portion, and wherein to update the trace data portion of the network packet further comprises to include the generated trace data in the trace data portion.

Example 11 includes the subject matter of any of Examples 1-10, and wherein to generate the trace data comprises to generate at least one of a time of interest, routing information, delay information, decision-making information, and information corresponding to one or more characteristics of a component the network computing device.

Example 12 includes the subject matter of any of Examples 1-11, and wherein to store the trace data to the trace buffer of the network computing device comprises to store at least a portion of the trace data of the network packet to the trace buffer.

Example 13 includes the subject matter of any of Examples 1-12, and wherein to store at least a portion of the trace data of the network packet comprises to (i) discard trace data without storing to a memory of the network computing device, (ii) filter the trace data based on an identifier of the source endpoint node, and (iii) store only the portion of the trace data according to a threshold associated with the trace data.

Example 14 includes the subject matter of any of Examples 1-13, and wherein to store the trace data of the network packet comprises to store the trace data to the trace buffer until the trace buffer is full.

Example 15 includes the subject matter of any of Examples 1-14, and wherein the trace buffer is a circular buffer.

Example 16 includes a method for tracing network performance, the method comprising receiving, by a network computing device, a network packet from a source endpoint node, wherein the network packet includes a header and a trace data portion; generating, by the network computing device, trace data corresponding to the received network packet; updating, by the network computing device, the trace data portion of the network packet to include the generated trace data from the trace buffer of the network computing device; and transmitting, by the network computing device, the updated network packet to a target endpoint node, wherein the updated network packet is usable to determine one or more network performance characteristics.

Example 17 includes the subject matter of Example 16, and wherein the trace data portion includes trace data of the source endpoint node.

Example 18 includes the subject matter of any of Examples 16 and 17, and further including extracting, by the network computing device, at least a portion of the trace data from the trace data portion of the network packet; and storing, by the network computing device, the extracted portion of trace data to a trace buffer of the network computing device.

Example 19 includes the subject matter of any of Examples 16-18, and further including retrieving, by the network computing device, the stored portion of the trace data from the trace buffer, wherein updating the trace data portion of the network packet comprise updating the trace data portion of the network packet with the retrieved portion of the trace data.

Example 20 includes the subject matter of any of Examples 16-19, and further including extracting, by the network computing device, at least a portion of the trace data from the trace data portion of the network packet; and storing, by the network computing device, the extracted portion of trace data to a trace buffer of the network computing device.

Example 21 includes the subject matter of any of Examples 16-20, and further including extracting, by the network computing device, at least a portion of the header of the network packet; and storing, by the network computing device, the extracted portion of the header to a trace buffer of the network computing device.

Example 22 includes the subject matter of any of Examples 16-21, and further including parsing, by the network computing device, the header of the network packet to retrieve an indicator inserted by the source endpoint node; and determining, by the network computing device, whether the indicator indicates to collect trace data, wherein storing, by the network computing device, the trace data of the network packet to the trace buffer of the network computing device comprises storing the trace data subsequent to a determination that the indicator indicates to collect trace data.

Example 23 includes the subject matter of any of Examples 16-22, and further including identifying, by the network computing device, a type of the trace data to be collected based on the indicator, wherein generating the trace data is based on the type of the trace data to be collected.

Example 24 includes the subject matter of any of Examples 16-23, and further including identifying, by the network computing device, a size of the trace data to be collected based on the indicator, wherein generating the trace data is based on the size of the trace data to be collected.

Example 25 includes the subject matter of any of Examples 16-24, and further including generating, by the network computing device, trace data for direct insertion into the trace data portion, and wherein updating the trace data portion of the network packet further comprises including the generated trace data in the trace data portion.

Example 26 includes the subject matter of any of Examples 16-25, and wherein generating the trace data comprises generating at least one of a time of interest, routing information, delay information, decision-making information, and information corresponding to one or more characteristics of a component the network computing device.

Example 27 includes the subject matter of any of Examples 16-26, and wherein storing the trace data to the trace buffer of the network computing device comprises storing at least a portion of the trace data of the network packet.

Example 28 includes the subject matter of any of Examples 16-27, and wherein storing at least a portion of the trace data of the network packet comprises (i) discarding trace data without storing to a memory of the network computing device, (ii) filtering the trace data based on an identifier of the source endpoint node, and (iii) storing only the portion of the trace data according to a threshold associated with the trace data.

Example 29 includes the subject matter of any of Examples 16-28, and wherein storing the trace data of the network packet comprises storing the trace data to the trace buffer until the trace buffer is full.

Example 30 includes the subject matter of any of Examples 16-29, and wherein storing the trace data of the network packet to the trace buffer comprises saving the trace data to a circular buffer.

Example 31 includes a network computing device comprising a processor; and a memory having stored therein a plurality of instructions that when executed by the processor cause the network computing device to perform the method of any of Examples 15-30.

Example 32 includes one or more machine readable storage media comprising a plurality of instructions stored thereon that in response to being executed result in a network computing device performing the method of any of Examples 15-30.

Example 33 includes a network computing device for tracing network performance, the network computing device comprising network communication management circuitry to receive a network packet from a source endpoint node, wherein the network packet includes a header and a trace data portion; and performance tracing circuitry to (i) generate trace data corresponding to the received network packet and (ii) update the trace data portion of the network packet to include the generated trace data from the trace buffer of the network computing device, wherein the network communication management circuitry is further to transmit the updated network packet to a target endpoint node, wherein the updated network packet is usable to determine one or more network performance characteristics.

Example 34 includes the subject matter of Example 33, and wherein the trace data portion includes trace data of the source endpoint node.

Example 35 includes the subject matter of any of Examples 33 and 34, and wherein the performance tracing circuitry is further to (i) extract at least a portion of the trace data from the trace data portion of the network packet and (ii) store the extracted portion of trace data to a trace buffer of the network computing device.

Example 36 includes the subject matter of any of Examples 33-35, and wherein the performance tracing circuitry is further to retrieve the stored portion of the trace data from the trace buffer, wherein to update the trace data portion of the network packet comprise to update the trace data portion of the network packet with the retrieved portion of the trace data.

Example 37 includes the subject matter of any of Examples 33-36, and wherein the performance tracing circuitry is further to (i) extract at least a portion of the trace data from the trace data portion of the network packet and (ii) store the extracted portion of trace data to a trace buffer of the network computing device.

Example 38 includes the subject matter of any of Examples 33-37, and wherein the performance tracing circuitry is further to (i) extract at least a portion of the header of the network packet and (ii) store the extracted portion of the header to a trace buffer of the network computing device.

Example 39 includes the subject matter of any of Examples 33-38, and wherein the performance tracing circuitry is further to (i) parse the header of the network packet to retrieve an indicator inserted by the source endpoint node and (ii) determine whether the indicator indicates to collect trace data, wherein to store the trace data of the network packet to the trace buffer of the network computing device comprises to store the trace data subsequent to a determination that the indicator indicates to collect trace data.

Example 40 includes the subject matter of any of Examples 33-39, and wherein the performance tracing circuitry is further to identify a type of the trace data to be collected based on the indicator, wherein to generate the trace data is based on the type of the trace data to be collected.

Example 41 includes the subject matter of any of Examples 33-40, and wherein the plurality of instructions further cause the network computing device to identify a size of the trace data to be collected based on the indicator, wherein to generate the trace data is based on the size of the trace data to be collected.

Example 42 includes the subject matter of any of Examples 33-41, and wherein the performance tracing circuitry is further to generate trace data for direct insertion into the trace data portion, and wherein to update the trace data portion of the network packet further comprises to include the generated trace data in the trace data portion.

Example 43 includes the subject matter of any of Examples 33-42, and wherein to generate the trace data comprises to generate at least one of a time of interest, routing information, delay information, decision-making information, and information corresponding to one or more characteristics of a component the network computing device.

Example 44 includes the subject matter of any of Examples 33-43, and wherein to store the trace data to the trace buffer of the network computing device comprises to store at least a portion of the trace data of the network packet.

Example 45 includes the subject matter of any of Examples 33-44, and wherein to store at least a portion of the trace data of the network packet comprises to (i) discard trace data without storing to a memory of the network computing device, (ii) filter the trace data based on an identifier of the source endpoint node, and (iii) store only the portion of the trace data according to a threshold associated with the trace data.

Example 46 includes the subject matter of any of Examples 33-45, and wherein to store the trace data of the network packet comprises to store the trace data to the trace buffer until the trace buffer is full.

Example 47 includes the subject matter of any of Examples 33-46, and wherein the trace buffer is a circular buffer.

Example 48 includes a network computing device for tracing network performance, the network computing device comprising network communication management circuitry to receive a network packet from a source endpoint node, wherein the network packet includes a header and a trace data portion; and means for generating trace data corresponding to the received network packet; means for updating the trace data portion of the network packet to include the generated trace data from the trace buffer of the network computing device; and wherein the network communication management circuitry is further to transmit the updated network packet to a target endpoint node, wherein the updated network packet is usable to determine one or more network performance characteristics.

Example 49 includes the subject matter of Example 48, and wherein the trace data portion includes trace data of the source endpoint node.

Example 50 includes the subject matter of any of Examples 48 and 49, and further including means for extracting at least a portion of the trace data from the trace data portion of the network packet; and means for storing the extracted portion of trace data to a trace buffer of the network computing device.

Example 51 includes the subject matter of any of Examples 48-50, and further including means for retrieving the stored portion of the trace data from the trace buffer, wherein the means for updating the trace data portion of the network packet comprise means for updating the trace data portion of the network packet with the retrieved portion of the trace data.

Example 52 includes the subject matter of any of Examples 48-51, and further including means for extracting at least a portion of the trace data from the trace data portion of the network packet; and means for storing the extracted portion of trace data to a trace buffer of the network computing device.

Example 53 includes the subject matter of any of Examples 48-52, and further including means for extracting at least a portion of the header of the network packet; and means for storing the extracted portion of the header to a trace buffer of the network computing device.

Example 54 includes the subject matter of any of Examples 48-53, and further including means for parsing the header of the network packet to retrieve an indicator inserted by the source endpoint node; and means for determining whether the indicator indicates to collect trace data, wherein the means for storing the trace data of the network packet to the trace buffer of the network computing device comprises means for storing the trace data subsequent to a determination that the indicator indicates to collect trace data.

Example 55 includes the subject matter of any of Examples 48-54, and further including means for identifying a type of the trace data to be collected based on the indicator, wherein generating the trace data is based on the type of the trace data to be collected.

Example 56 includes the subject matter of any of Examples 48-55, and further including means for identifying a size of the trace data to be collected based on the indicator, wherein generating the trace data is based on the size of the trace data to be collected.

Example 57 includes the subject matter of any of Examples 48-56, and further including means for generating trace data for direct insertion into the trace data portion, and wherein the means for updating the trace data portion of the network packet further comprises means for including the generated trace data in the trace data portion.

Example 58 includes the subject matter of any of Examples 48-57, and wherein the means for generating the trace data comprises means for generating at least one of a time of interest, routing information, delay information, decision-making information, and information corresponding to one or more characteristics of a component the network computing device.

Example 59 includes the subject matter of any of Examples 48-58, and wherein the means for storing the trace data to the trace buffer of the network computing device comprises means for storing at least a portion of the trace data of the network packet.

Example 60 includes the subject matter of any of Examples 48-59, and wherein the means for storing at least a portion of the trace data of the network packet comprises means for (i) discarding trace data without storing to a memory of the network computing device, (ii) filtering the trace data based on an identifier of the source endpoint node, and (iii) storing only the portion of the trace data according to a threshold associated with the trace data.

Example 61 includes the subject matter of any of Examples 48-60, and wherein the means for storing the trace data of the network packet comprises means for storing the trace data to the trace buffer until the trace buffer is full.

Example 62 includes the subject matter of any of Examples 48-61, and wherein the means for storing the trace data of the network packet to the trace buffer comprises means for saving the trace data to a circular buffer.

Example 63 includes a source endpoint node for tracing network performance, the source endpoint node including one or more processors; and one or more data storage devices having stored therein a plurality of instructions that, when executed by the one or more processors, cause the source endpoint node to generate a network packet that includes a header with a plurality of fields; allocate a trace data portion in the data portion of the network packet; insert a trace data indicator into one of the fields of the header, wherein the trace data indicator indicates whether the network packet includes a trace data portion; and transmit the generated network packet towards a target endpoint node, wherein the generated network packet is usable to determine one or more network performance characteristics.

Example 64 includes the subject matter of Example 63, and wherein the plurality of instructions further cause the source endpoint node to generate trace data for the network packet and insert the generated trace data into the trace data portion of the allocated trace data portion.

Example 65 includes the subject matter of any of Examples 63 and 64, and wherein to transmit the generated network packet towards the target endpoint node comprises to transmit the generated network packet to a network computing device, and wherein the trace data indicator is usable by the network computing device to determine whether to generate trace data of the network computing device.

Example 66 includes the subject matter of any of Examples 63-65, and wherein the plurality of instructions further cause the source endpoint node to insert a location indicator that indicates a location in the trace data portion of the network packet at which the network computing device is to store the trace data of the network computing device.

Example 67 includes the subject matter of any of Examples 63-66, and wherein the plurality of instructions further cause the source endpoint node to insert a size indicator that indicates a maximum size in the trace data portion of the network packet allocated to the network computing device to store the trace data of the network computing device.

Example 68 includes the subject matter of any of Examples 63-67, and wherein the plurality of instructions further cause the source endpoint node to insert a type indicator that indicates a type of trace data the network computing device is to generate.

Example 69 includes a method for tracing network performance, the method including generating, by a source endpoint node, a network packet that includes a header with a plurality of fields; allocating, by the source endpoint node, a trace data portion in the data portion of the network packet; inserting, by the source endpoint node, a trace data indicator into one of the fields of the header, wherein the trace data indicator indicates whether the network packet includes a trace data portion; and transmitting, by the source endpoint node, the generated network packet towards a target endpoint node, wherein the generated network packet is usable to determine one or more network performance characteristics.

Example 70 includes the subject matter of Example 69, and further comprising generating, by the source endpoint node, trace data for the network packet and insert the generated trace data into the trace data portion of the allocated trace data portion.

Example 71 includes the subject matter of any of Examples 69 and 70, and wherein transmitting the generated network packet towards the target endpoint node comprises transmitting the generated network packet to a network computing device, and wherein the trace data indicator is usable by the network computing device to determine whether to generate trace data of the network computing device.

Example 72 includes the subject matter of any of Examples 69-71, and further comprising inserting, by the source endpoint node, a location indicator that indicates a location in the trace data portion of the network packet at which the network computing device is to store the trace data of the network computing device.

Example 73 includes the subject matter of any of Examples 69-72, and further comprising inserting, by the source endpoint node, a size indicator that indicates a maximum size in the trace data portion of the network packet allocated to the network computing device to store the trace data of the network computing device.

Example 74 includes the subject matter of any of Examples 69-73, and further comprising inserting, by the source endpoint node, a type indicator that indicates a type of trace data the network computing device is to generate.

Example 75 includes a source endpoint node comprising a processor; and a memory having stored therein a plurality of instructions that when executed by the processor cause the source endpoint node to perform the method of any of claims 69-74.

Example 76 includes one or more machine readable storage media comprising a plurality of instructions stored thereon that in response to being executed result in a source endpoint node performing the method of any of claims 69-74.

Example 77 includes a source endpoint node comprising means for performing the method of any of claims 69-74.

Example 78 includes a target endpoint node for tracing network performance, the target endpoint node including one or more processors; and one or more data storage devices having stored therein a plurality of instructions that, when executed by the one or more processors, cause the source endpoint node to receive a network packet from a network computing device, wherein the network packet includes a header with a plurality of fields; extract trace data from a trace data portion of the network packet, wherein the trace data includes data generated by a plurality of network computing devices in which the network packet was received at and forwarded from, wherein the plurality of network computing devices includes the network computing device; and store trace data at a trace data buffer of a network interface controller of the target endpoint node.

Example 79 includes the subject matter of Example 78, and wherein the plurality of instructions further cause the target endpoint node to (i) parse a predetermined one of the fields of the header to extract a trace data indicator and (ii) determine whether the network packet includes a trace data portion based on the trace data indicator, and wherein to extract the trace data from the trace data portion of the network packet comprises to extract the trace data in response to a determination that the network packet includes the trace data portion.

Example 80 includes the subject matter of any of Examples 78 and 79, and wherein the plurality of instructions further cause the target endpoint node to move the trace data from the trace data buffer to a portion of memory external to the network interface controller allocated to store the trace data.

Example 81 includes the subject matter of any of Examples 78-80, and wherein the plurality of instructions further cause the target endpoint node to (i) analyze the trace data stored in the allocated portion of memory external to the network interface controller and (ii) identify one or more network performance characteristics based on the analysis.

Example 82 includes the subject matter of any of Examples 78-81, and wherein the network packet further includes a payload portion, and wherein the plurality of instructions further cause the target endpoint node to (i) extract the payload portion of the network packet and (ii) store the extracted payload portion into a portion of memory external to the network interface controller allocated to store the payload.

Example 83 includes a method for tracing network performance, the method including receiving, by a target endpoint node, a network packet from a network computing device, wherein the network packet includes a header with a plurality of fields; extracting, by the target endpoint node, trace data from a trace data portion of the network packet, wherein the trace data includes data generated by a plurality of network computing devices in which the network packet was received at and forwarded from, wherein the plurality of network computing devices includes the network computing device; and storing, by the target endpoint node, trace data at a trace data buffer of a network interface controller of the target endpoint node.

Example 84 includes the subject matter of Example 83, and further comprising parsing, by the target endpoint node, a predetermined one of the fields of the header to extract a trace data indicator; and determining, by the target endpoint node, whether the network packet includes a trace data portion based on the trace data indicator, wherein extracting the trace data from the trace data portion of the network packet comprises extracting the trace data in response to a determination that the network packet includes the trace data portion.

Example 85 includes the subject matter of any of Examples 83 and 84, and further comprising moving, by the target endpoint node, the trace data from the trace data buffer to a portion of memory external to the network interface controller allocated to store the trace data.

Example 86 includes the subject matter of any of Examples 83-85, and further comprising: analyzing, by the target endpoint node, the trace data stored in the allocated portion of memory external to the network interface controller; and identifying, by the target endpoint node, one or more network performance characteristics based on the analysis.

Example 87 includes the subject matter of any of Examples 83-86, and further comprising: extracting, by the target endpoint node, a payload portion of the network packet; and storing, by the target endpoint node, the extracted payload portion into a portion of memory external to the network interface controller allocated to store the payload.

Example 88 includes a target endpoint node including a processor; and a memory having stored therein a plurality of instructions that when executed by the processor cause the target endpoint node to perform the method of any of claims 83-87.

Example 89 includes one or more machine readable storage media comprising a plurality of instructions stored thereon that in response to being executed result in a target endpoint node performing the method of any of claims 83-87.

Example 90 includes a target endpoint node comprising means for performing the method of any of claims 83-87.

1. A network computing device for tracing network performance, the network computing device comprising:
one or more processors; and
one or more data storage devices having stored therein a plurality of instructions that, when executed by the one or more processors, cause the network computing device to:
receive a network packet generated by a source endpoint node, wherein the network packet includes a header and a trace data portion;
generate trace data corresponding to the received network packet;
update the trace data portion of the network packet to include the trace data generated for the received network packet; and
transmit the updated network packet towards a target endpoint node, wherein the updated network packet is usable to determine one or more network performance characteristics.

2. The network computing device of claim 1, wherein the plurality of instructions further cause the network computing device to:
extract at least a portion of the trace data from the trace data portion of the network packet;
store the extracted portion of trace data to a trace buffer of the network computing device; and
retrieve the stored portion of the trace data from the trace buffer,
wherein to update the trace data portion of the network packet comprise to update the trace data portion of the network packet with the retrieved portion of the trace data.

3. The network computing device of claim 2, wherein the plurality of instructions further cause the network computing device to:
extract at least a portion of the trace data from the trace data portion of the network packet; and
store the extracted portion of trace data to a trace buffer of the network computing device.

4. The network computing device of claim 3, wherein the plurality of instructions further cause the network computing device to:
extract at least a portion of the header of the network packet; and
store the extracted portion of the header to a trace buffer of the network computing device.

5. The network computing device of claim 1, wherein the plurality of instructions further cause the network computing device to:
parse the header of the network packet to retrieve an indicator inserted by the source endpoint node; and
determine whether the indicator indicates to collect trace data,
wherein to store the trace data of the network packet to the trace buffer of the network computing device comprises to store the trace data subsequent to a determination that the indicator indicates to collect trace data.

6. The network computing device of claim 5, wherein the plurality of instructions further cause the network computing device to identify at least one of a type of the trace data to be collected based on the indicator and a size of the trace data to be collected based on the indicator, wherein to generate trace data corresponding to the received network packet comprises to generate the trace data based on at least one of the type and size of the trace data to be collected.

7. The network computing device of claim 1, wherein the plurality of instructions further cause the network computing device to generate trace data for direct insertion into the trace data portion, and wherein to update the trace data portion of the network packet further comprises to include the generated trace data in the trace data portion.

8. The network computing device of claim 1, wherein to generate the trace data comprises to generate at least one of a time of interest, routing information, delay information, decision-making information, and information corresponding to one or more characteristics of a component the network computing device.

9. The network computing device of claim 1, wherein to store the trace data to the trace buffer of the network computing device comprises to store at least a portion of the trace data to the trace buffer.

10. The network computing device of claim 1, wherein to store at least a portion of the trace data to the trace buffer comprises to (i) discard trace data without storing to a memory of the network computing device, (ii) filter the trace data based on an identifier of the source endpoint node, and (iii) store only the portion of the trace data according to a threshold associated with the trace data.

11. One or more computer-readable storage media comprising a plurality of instructions stored thereon that in response to being executed cause a network computing device to:
receive a network packet generated by a source endpoint node, wherein the network packet includes a header and a trace data portion;
generate trace data corresponding to the received network packet;
update the trace data portion of the network packet to include the generated trace data from the trace buffer of the network computing device; and
transmit the updated network packet towards a target endpoint node, wherein the updated network packet is usable to determine one or more network performance characteristics.

12. The one or more computer-readable storage media of claim 11, wherein the plurality of instructions further cause the network computing device to:
extract at least a portion of the trace data from the trace data portion of the network packet;
store the extracted portion of trace data to a trace buffer of the network computing device; and
retrieve the stored portion of the trace data from the trace buffer,
wherein to update the trace data portion of the network packet comprise to update the trace data portion of the network packet with the retrieved portion of the trace data.

13. The one or more computer-readable storage media of claim 12, wherein the plurality of instructions further cause the network computing device to:
extract at least a portion of the trace data from the trace data portion of the network packet; and
store the extracted portion of trace data to a trace buffer of the network computing device.

14. The one or more computer-readable storage media of claim 13, wherein the plurality of instructions further cause the network computing device to:
extract at least a portion of the header of the network packet; and
store the extracted portion of the header to a trace buffer of the network computing device.

15. The one or more computer-readable storage media of claim 11, wherein the plurality of instructions further cause the network computing device to:
parse the header of the network packet to retrieve an indicator inserted by the source endpoint node; and
determine whether the indicator indicates to collect trace data,
wherein to store the trace data of the network packet to the trace buffer of the network computing device comprises to store the trace data subsequent to a determination that the indicator indicates to collect trace data.

16. The one or more computer-readable storage media of claim 15, wherein the plurality of instructions further cause the network computing device to identify a type of the trace data to be collected based on the indicator, wherein to generate the trace data is based on the type of the trace data to be collected.

17. The one or more computer-readable storage media of claim 15, wherein the plurality of instructions further cause the network computing device to identify a size of the trace data to be collected based on the indicator, wherein to generate the trace data is based on the size of the trace data to be collected.

18. The one or more computer-readable storage media of claim 11, wherein the plurality of instructions further cause the network computing device to generate trace data for direct insertion into the trace data portion, and wherein to update the trace data portion of the network packet further comprises to include the generated trace data in the trace data portion.

19. The one or more computer-readable storage media of claim 11, wherein to generate the trace data comprises to generate at least one of a time of interest, routing information, delay information, decision-making information, and information corresponding to one or more characteristics of a component the network computing device.

20. The one or more computer-readable storage media of claim 11, wherein to store the trace data to the trace buffer of the network computing device comprises to store at least a portion of the trace data to the trace buffer.

21. The one or more computer-readable storage media of claim 20, wherein to store at least a portion of the trace data to the trace buffer comprises to (i) discard trace data without storing to a memory of the network computing device, (ii) filter the trace data based on an identifier of the source endpoint node, and (iii) store only the portion of the trace data according to a threshold associated with the trace data.

22. A network computing device for tracing network performance, the network computing device comprising:
network communication management circuitry to receive a network packet from a source endpoint node, wherein the network packet includes a header and a trace data portion; and
means for generating trace data corresponding to the received network packet;
means for updating the trace data portion of the network packet to include the generated trace data from the trace buffer of the network computing device; and
wherein the network communication management circuitry is further to transmit the updated network packet to a target endpoint node, wherein the updated network packet is usable to determine one or more network performance characteristics.

23. The network computing device of claim 22, further comprising:
means for parsing the header of the network packet to retrieve an indicator inserted by the source endpoint node; and
means for determining whether the indicator indicates to collect trace data,
wherein the means for storing the trace data of the network packet to the trace buffer of the network computing device comprises means for storing the trace data subsequent to a determination that the indicator indicates to collect trace data.

24. The network computing device of claim 22, further comprising:
means for extracting at least a portion of the trace data from the trace data portion of the network packet;
means for storing the extracted portion of trace data to a trace buffer of the network computing device; and
means for retrieving the stored portion of the trace data from the trace buffer,
wherein the means for updating the trace data portion of the network packet comprise means for updating the trace data portion of the network packet with the retrieved portion of the trace data.

25. The network computing device of claim 22, further comprising means for generating trace data for direct insertion into the trace data portion, and wherein the means for updating the trace data portion of the network packet further comprises means for including the generated trace data in the trace data portion.
